(19) United States
(12) Patent Application Publication
(10) Pub. No.: US 2017/0339284 A1
(43) Pub. Date: Nov. 23, 2017

(54) METHOD FOR COLOR MATCHING PRINTERS

(71) Applicant: Océ-Technologies B.V., Venlo (NL)

(72) Inventors: Erwin A.R. VAN DER LINDEN, Venlo (NL); Arjen D. GOLDSCHMIDT, Venlo (NL)

(73) Assignee: Océ-Technologies B.V., Venlo (NL)

(21) Appl. No.: 15/674,971

(22) Filed: Aug. 11, 2017

Related U.S. Application Data
(63) Continuation of application No. PCT/EP2016/053487, filed on Feb. 18, 2016.

(30) Foreign Application Priority Data
Feb. 19, 2015 (EP) 15155696.6

(51) Int. Cl. H04N 1/00; H04N 1/60

(52) U.S. Cl. CPC H04N 1/00023; H04N 1/6036; H04N 1/6052

(57) ABSTRACT

A method is provided for printing color images using a color workflow. This workflow results in equal output colors from two print systems. For a first print system an existing color output profile for converting colors is used. An actual output color profile for the first print system is obtained from color measurement data that relate device colorant coordinates of the first print system to device independent color data. The existing output color profile does not correspond to the color measurement data. For a second print system, an additional output color profile is obtained from color measurement data. The color workflow that is applied in the second print system for converting colors of an input image is made by combining the existing output color profile, the actual output color profile and the additional color output profile, wherein the actual output color profile is applied in an inverse direction (A2B).

### BACKGROUND OF THE INVENTION

### 1. Field of the Invention

The present invention relates to a method for printing color images using a color workflow that results in comparable colors from different print systems. In particular, the invention relates to a workflow for obtaining colors from an additional print system that are similar to colors obtained from an existing print system. Furthermore, the invention relates to a print system that is configured for applying the method to obtain similar colors as obtained from an existing print system.

### 2. Description of the Related Art

The need to control colors in a color image rendering apparatus, such as a monitor or a printer, as well as in a color image generating device, such as a camera and a scanner, has resulted in various color management systems. The most familiar system is the one supported by the International Color Consortium (ICC), although other systems exist that give comparable results. Colors in a digital image are generally specified in device dependent coordinates. Familiar coordinate spaces are RGB- and CMYK-spaces, but other spaces, depending on a configuration of a device wherein the digital image is processed, may be applicable. A color, associated with a point in a coordinate space, may be determined in physical units by a measuring instrument. Thus, a color is positioned in a device independent color space, such as CIE XYZ and CIE Lab. A conversion between the device dependent coordinate space and the device independent color space is saved as a color profile, that is applicable for processing images of a specific device.

Traditionally, color profiles are associated with a situation wherein a digital image is transferred from a first device, an input device, to a second device, an output device, such as from a scanner to a printer. In such a case, two color profiles are engaged, one for each device. First, the input device coordinates are converted to a device independent color and second, the device independent color is converted to output device coordinates. The combination of two color profiles in this way is a basic color workflow as envisaged by the ICC. The device independent color space acts as a profile connecting space (PCS). The combination of the profiles is not necessarily done during processing of an image, but may also be done in a separate process, thereby obtaining a conversion means that is specifically suitable for transferring images between the two specific devices. This conversion means is known as a device link profile.

In printing workflows, there is no input device as such, but still an input color profile is applied to convert the colors as specified in a digital input image and a similar color workflow as above arises. Most often, an input color profile relates to standard print conditions, such as SWOP, GRACoL2000 and FOGRA39, but also standard RGB (sRGB) is used. Also in these workflows, device link profiles are known for converting colors in digital images directly into colors suitable for printing. It is noted, that using a PCS is just one way of composing these device link profiles, but other ways, using a color model for the input and output color spaces, are very well feasible.

A color profile for an input device is made from measurements wherein predetermined colors are introduced to an input device and a corresponding device response is determined. From these measurements a table for converting a device response to a color is determined. Intermediate points from the tabulated values are converted by interpolation. A color profile relating to standard printing conditions has a similar structure. Both color profiles may be used as input color profiles for converting specific coordinates to a PCS. For this conversion, a table referred to as AtoB, or A2B, is used, indicating the direction of the conversion, wherein A refers to a specific color coordinate space, whereas B refers to the PCS. A color profile usually also comprises an inverse table, known as BtoA, or B2A, for a conversion in the opposite direction. A color profile for an output device, on the other hand, may be made from measurements wherein a device stimulation is introduced to an output device for obtaining colored areas that may be measured by a measuring instrument. In this case, a conversion table called BtoA, or B2A, is aimed at, in order to convert a color to device stimulation coordinates. Also included in the profile is an inverse table AtoB, or A2B, that is convenient in some color workflows. Thus, the color profiles facilitate conversion of colors from a PCS to a device space and vice versa.

In addition to the mentioned profiles, there are also abstract profiles that convert a color in a PCS to another color, in the same PCS. These abstract profiles are convenient in constructing a color workflow, wherein colors are adjusted in a predefined way, such as for adding contrast in an image. In fact, a color workflow may concatenate several color profiles for obtaining a new color profile, the type of which depends on the type of the color profiles in the set.

A further issue exists in the selection of an appropriate rendering intent, which defines a way to interpret the color data of a profile. A number of predetermined rendering intents exist, called absolute, relative, perceptual and saturation rendering intent. The interpretation of these rendering intents is well known and it may be necessary to make an appropriate selection therefor. Furthermore, it is known that a color profile depends on a medium that is used in the printing process. In a convenient working method, a color workflow is associated with a print medium, or a set of media.

An often used color workflow is the color proofing workflow, or simulation color workflow. This comes in useful, when an image is printed on a proofing device, having a larger gamut than a production device. Without proofing workflow, this may lead to different colors in the output of the proofing device than would be obtained by printing the image on the production device, depending on the colors used in the image. Thus, it may lead to an inaccurate proofing. Many software applications therefore allow the definition of a simulation profile, which is an output color profile of the device to be simulated and concatenate an input color profile (A2B), the B2A-table of the simulation profile, the A2B-table of the simulation profile and the output profile (B2A) of the proofing device. This results in similar colors in the output of the proofing device as the output of the production device, if the simulation profile is accurate, meaning that the production device prints colors according to its output color profile.

In practice, however, a situation may be encountered, wherein a new print system is added to an existing print system, which employs an acknowledged color output profile, or, alternatively, a device link profile. The new print system is to be configured to obtain accurately the same colors as the existing print system, without any change to the established workflow for the existing print system. If the color output profile of the existing print system were accurate, the situation would be the same as for the proofing color workflow. The accuracy may be determined by obtaining color measurement data that relate device colorant coordinates of the existing print system to device independent color data. If the determined accuracy is insufficient, no color workflow is known, which poses a problem for appending an additional print system to an existing set of print systems.

An object of the present invention is to provide a color workflow that allows to expand an existing set of print systems with additional ones, whether or not of similar type and obtaining similar color output.

### SUMMARY OF THE INVENTION

According to the present invention, a method for printing color images is provided, using a color workflow that results in comparable colors from an existing print system and an additional print system, the existing print system applying an existing output color profile for converting colors of an input image, the additional print system applying said color workflow for converting colors of an input image, the method comprising the steps of: a) obtaining an additional output color profile for the additional print system from color measurement data that relate device colorant coordinates of the additional print system to device independent color data; b) obtaining an actual output color profile for the existing print system from color measurement data that relate device colorant coordinates of the existing print system to device independent color data; c) obtaining the existing output color profile, and d) combining the existing output color profile, the actual output color profile and the additional color output profile in the color workflow, wherein the existing output color profile is different from the actual output color profile and the actual output color profile is applied in an inverse direction in the step of combining output color profiles.

This color workflow has the following effect. First a color to be printed on the additional print system is converted into coordinates suitable for the existing print system by the existing output color profile, in the same way as would have been done for the existing print system. The actual color profile, corresponding to measurement data taken from the existing print system, reflects the relation between the coordinates of the existing print system and the profile connecting space (PCS) that is applicable. By applying the actual color profile in the inverse direction (A2B), the existing print system coordinates are converted to a color in the PCS. This color is then converted to coordinates in the additional print system, thus enabling this print system to reproduce the color as intended to be printed by the existing print system.

Note that for the application of this color workflow, three output profiles need to be specified, in contrast with a usual simulation workflow that only requires two output profiles. In an embodiment, a combination output profile is made by combining the usual B2A-table, also known as output table, of the existing output color profile with the inverse table, this is the A2B-table, also known as the input table, of the actual output color profile. This extraordinary color profile, which is extraordinary because the A2B- and B2A-table are not each others inverse, as is usually the case, may be used to define a color workflow in a user interface that only allows an input of a single simulation profile. The simulation workflow has in that case the same result as the invented workflow.

Further details of the invention are given in the dependent claims. The present invention may also be embodied in a print system for printing color images. A print system should be understood to broadly cover any machine that has a printing function, including multifunctional machines that have a scanning, printing and copying function.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a number of known color workflows for printing data;

FIG. 2 shows a color workflow according to the invented method;

FIG. 3 is a user interface for defining a color workflow, and

FIG. 4 shows the individual steps for obtaining an invented color workflow.

### DETAILED DESCRIPTION OF EMBODIMENTS

The present invention will now be described with reference to the accompanying drawings, wherein the same or similar elements are identified with the same reference numeral.

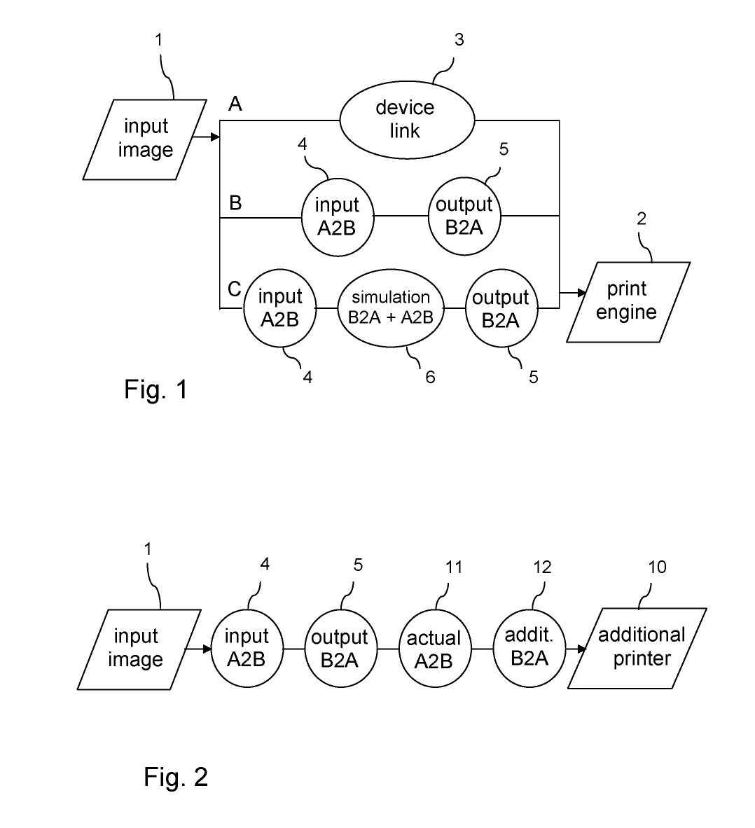

In FIG. 1, an input image 1 comprising color information is scheduled to be printed on print engine 2. An image in the present context means anything that can be displayed, including text and graphics. Three possible, known workflows are available for converting the color information into printer coordinates. A selection of a workflow may be made automatically in the digital front end, where the input data are rendered, but, alternatively, a user may define a preferred workflow, if it is compatible with the input data. The input data may comprise an input color profile for converting the input image data into a Profile Connecting Space (PCS), such as the CIE-Lab color space. Often, the input data refer to standard printing conditions, such as SWOP or FOGRA39 or a standard color space, such as sRGB. In case no input profile is included in the input data, an input color profile is either available in the digital front end or may be found on the internet. Workflow A refers to a case wherein the color input data is directly converted by a device link profile 3, without using a PCS. Workflow B is the standard ICC workflow that comprises an input color profile 4 and an output color profile 5 that both may comprise a relation between a specific device or a standard color device and a PCS. The A2B-table of the input profile is joined with the B2A-table of the output profile to obtain a color conversion that is compatible with the color specifications of the print engine 2. Workflow C is a simulation color workflow that is used to convert the colors of the input image in such a way that the colors in the output of the print engine 2 do not extend beyond a gamut of a simulated device. In this simulated device, the simulation profile 6 is used as an output profile. It is assumed in this workflow that the simulated device accurately, i.e. according to color measurements, renders the colors of the simulation profile. In the simulation workflow C, the simulation profile is applied twice, once to convert a PCS color to the simulated device coordinates, and a second time to convert the simulated device coordinates back to the PCS. In practice, the accuracy assumption does not always hold. Print systems apply color profiles that are colorimetrically not accurate, but it is still required to match an additional printer to an existing print system, while maintaining the inaccurate profile.

FIG. 2 shows a workflow that may be used in such a case. The print engine 2 of FIG. 1 is considered to be part of an existing print system for which the workflows and profiles of FIG. 1 are maintained. An input image 1 is printed on an additional printer 10. First, the input data are converted by the input and output profiles 4 and 5 in the same way as in workflow B in FIG. 1. If a device link profile is available, it is also possible to replace the profiles 4 and 5 by the device link profile, as in workflow A in FIG. 1. An actual profile 11, that accurately describes the color behaviour of the existing print engine 2, is inserted to convert a color as defined in print engine 2 coordinates to the PCS. This actual profile is a new profile obtained from color measurements on print engine 2. It is therefore an output color profile that is applied in the inverse direction. Once a color is in the PCS, it may be converted to coordinates of an additional printer by an additional output profile 12, that is obtained from color measurements on the additional printer 10 in the usual way. Thus, the output colors of additional printer 10 are similar to the colors of print engine 2.

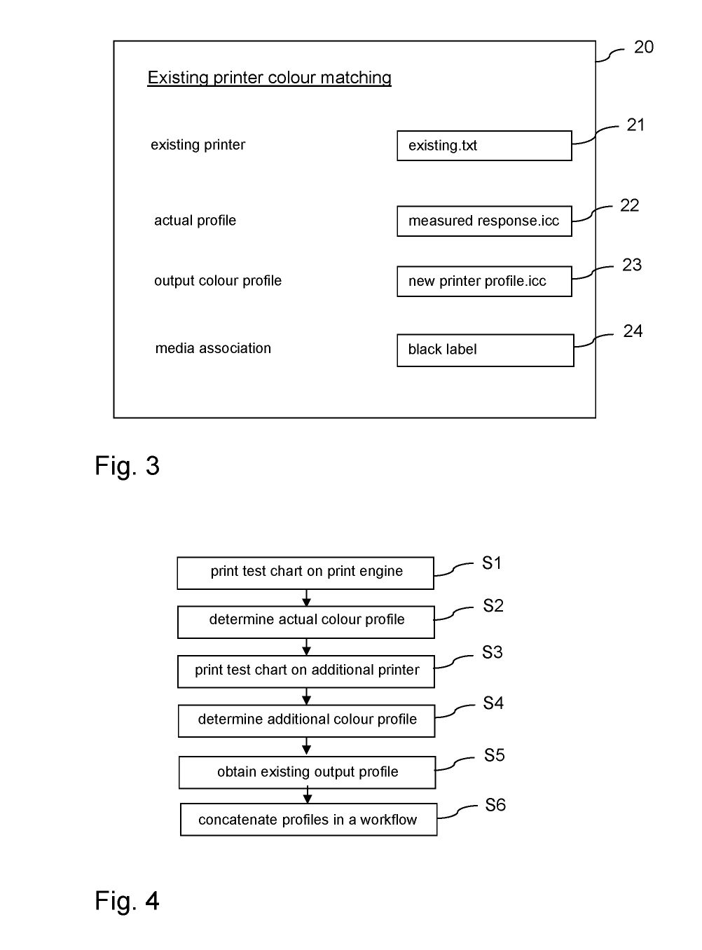

FIG. 3 shows a user interface 20 for defining the color matching workflow. For an existing printer, the existing printer parameter set 21 is selected. This set comprises the complete definition of parameters that are used in the color workflow of the existing printer, such as an input and output color profile (or a device link profile), the applied rendering intent, the black point compensation method, the pure color preservation, etc. Thus, in the color matching workflow, an exact copy of the color workflow for the existing engine can be applied. Also, an actual profile 22, reflecting an actual relation between the existing printer coordinates and the PCS, is inserted and a color output profile 23 as determined from measurements on the additional printer 10. The rendering intent for using the actual profile 22 and color output profile 23 is preferably the absolute rendering intent, or, alternatively, the relative rendering intent without black point compensation, in order to convert the colors as directly as possible. However, in this embodiment, this parameter is not selectable, but fixed, but alternatively it is selectable. Furthermore, in box 24, this color workflow may be associated with a medium from the medium list of additional printer 10, such that this workflow is automatically selected when a user selects this medium to print the input image.

FIG. 4 shows the individual steps that are taken to obtain the required profile data to apply the color workflow as shown in FIG. 2. In step S1, a test chart is printed on an existing print engine, such as print engine 2 in FIG. 1. An actual color profile 11 is determined in step S2. In step S3, a similar test chart is printed on the new, additional printer 10 in FIG. 2, for which an output color profile 12 is determined in step S4. Subsequently, in step S5, the existing output profile 5 as used for the existing print engine 2 is obtained. Then, in step S6, these profiles are concatenated as indicated in FIG. 2. It is noted, that several commercial software programs, such as X-rite i1 Profiler, exist for making the necessary calculations, both for making color profiles from test chart measurements and for concatenating various profiles. Also, Color Management Modules (CMM) by Adobe and Microsoft, are capable of assembling various color profiles in a color workflow. In the present embodiment, non-commercial, proprietary software has been used to make the various interpolations and interpretations that are necessary to obtain the profiles, but this is well known in the art of color management.

The invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. A method for printing color images using a color workflow that results in equal colors from an existing print system and an additional print system, the existing print system applying an existing output color profile for converting colors of an input image, the additional print system applying said color workflow for converting colors of an input image, the method comprising the steps of:
a) obtaining an additional output color profile for the additional print system from color measurement data that relate device colorant coordinates of the additional print system to device independent color data;
b) obtaining an actual output color profile for the existing print system from color measurement data that relate device colorant coordinates of the existing print system to device independent color data;
c) obtaining the existing output color profile;
d) combining the existing output color profile, the actual output color profile and the additional color output profile in the color workflow, and
e) converting the colors of an input image according to the color workflow and printing the converted image using the additional print system,
wherein the existing output color profile does not correspond to the color measurement data in step b) and the actual output color profile is applied in an inverse direction (A2B) in the step of combining output color profiles.

2. The method according to claim 1, wherein the color workflow is stored as an output color profile for the additional print system.

3. The method according to claim 1, wherein the actual output color profile and the additional output color profile are combined in a device link profile.

4. The method according to claim 1, wherein the color workflow is combined with an input color profile to a device link profile for the additional print system.

5. The method according to claim 4, wherein a number of color profiles of the color workflow are combined in a device link profile.

6. The method according to claim 1, wherein the color workflow is associated with a medium that is applicable in the additional print system, such that the color workflow is applied when the medium is selected as output medium for an input image to be printed.

7. The method according to claim 1, wherein an output table of the existing output color profile and an input table of the actual output color profile are stored as an extraordinary color profile, wherein the two tables are not each others inverse.

8. A print system for printing color images using a color workflow for converting colors of an input image resulting in equal colors as obtained from an existing print system, the existing print system applying an existing color output profile for converting colors of an input image, the print system being configured to combine the existing output color profile, an actual output color profile, that relates device colorant coordinates of the existing print system to device independent color data, and an additional output color profile, that relates device colorant coordinates of the print system to device independent color data, in the color workflow, wherein the existing output color profile does not correspond to the color measurement data of the existing print system and the actual output color profile is applied in an inverse direction (A2B).

9. The print system according to claim 8, wherein a user interface is configured to enable a selection of an existing color output profile, an actual output color profile and an additional output color profile that are combined in the color workflow.

10. The print system according to claim 8, wherein the color workflow is associated with a medium that is applicable in the print system, such that the color workflow is applied when the medium is selected as output medium for an input image to be printed.
